(19) United States
(12) Patent Application Publication
(10) Pub. No.: US 2012/0150549 A1
(43) Pub. Date: Jun. 14, 2012

(54) Method and system for providing engineering services without up front fees in exchange for royalty or contingency fees.

(75) Inventor: Robert DeBardeleben, Arvada, CO (US)

(73) Assignee: FREEENGINEERS, LLC, Arvada, CO (US)

(21) Appl. No.: 13/035,941

(22) Filed: Feb. 26, 2011

Related U.S. Application Data
(60) Provisional application No. 61/313,589, filed on Mar. 12, 2010.

(51) Int. Cl. G06Q 30/00

(52) U.S. Cl. 705/1.1

(57) ABSTRACT

A method and system are provided to create engineering documents or intellectual property using engineering techniques as needed to manufacture a product or develop a service. Engineering services are provided to inventors or product developers without fee in exchange for a royalty or contingency as compensation for said engineering services. Computer systems are used as a communication device between the inventor or product developer and the engineering service provider to exchange ideas as well as exchange electronic files containing the engineering as it is developed to manufacture the product, service, or invention.

This method and system of creating engineering documentation applies to all forms of engineering, including but not limited to Mechanical, Electrical, Software, Environmental, Civil, Chemical, and Computer Engineering, and is also applicable to all forms of products or services including but not limited to Automotive, Aerospace, Medical, Consumer, Commercial, Defense, Electronics, Household Goods, and Sporting Goods.

### PARENT CASE TEXT

### Cross-Reference to Related Applications

This application for patent claims priority to, and hereby incorporates by reference, U.S. Provisional Application Ser. No. 61/313,589, entitled “Method for developing intellectual property for inventors without labor fee in exchange for royalty,” filed on Mar. 12, 2010, with the United States Patent and Trademark Office.

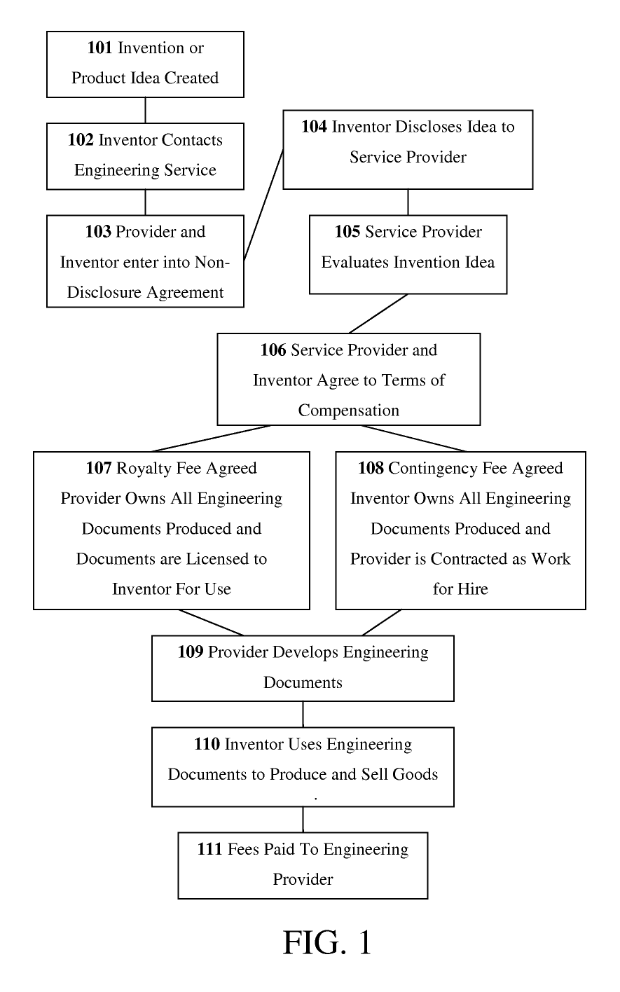

Shown in FIG. 1, are the method and system steps to provide engineering services without fee in exchange for a royalty or contingency fee based on the sales of the product or service.

The Method and System is comprised of the following:
101 Step 1: Inventor or Product Developer creates a product idea
102 Step 2: Inventor or product developer contacts Engineering Provider.
103 Step 3: Inventor or Product Developer together with Engineering Provider agrees to and assigns a Non-Disclosure Agreement.
104 Step 4: Inventor or Product Developer discloses the invention or product idea to the Engineering Provider.
105 Step 5: Engineering Provider evaluates the invention or product idea for marketability, feasibility and decides whether to accept the task as work.
106 Step 6: Inventor or Product Developer negotiates terms and degree of compensation and involvement with Engineering Provider.
107 Step 7A: Agreed to royalty terms and therefore engineering produced shall be retained by the engineering provider, licensed back to the inventor for use.
108 Step 7B: Agreed to contingency terms and therefore engineering produced shall be retained by the inventor and the engineering provider is considered to be work for hire.
109 Step 8: Engineering Provider develops engineering documents within specifications of Inventor or Product Developer.
110 Step 9: Inventor or Product Developer uses the engineering documents in the manufacture of prototypes of the product.
111 Step 10: Inventor or Product Developer provides royalty or contingency payment to Engineering Provider upon sales of the product developed by the Engineer Provider.

All elements are optional except for the creation of engineering documentation by Engineering Provider free of charge, and the payment of royalties or contingencies by the Inventor or Product Developer, to the Engineering Provider, upon sales of the product created using the engineering documents created by the engineering provider.

Steps described are preferred and based on logical progression. However, steps may be added or deleted depending on the maturity of the idea being presented to Engineering Provider. For example, Step 6 may be performed at any point in the process; however it is preferred business practice to negotiate terms before work is performed.

### REFERENCES CITED

### Related US Patent Documents

| Application Number | Filing Date | Patent Number | Issue Date |
|---|---|---|---|
| 10/551,440 | Apr. 5, 2004 | 2006/0200399 A1 | Sep. 7, 2006 |
| 10/718/041 | Nov. 18, 2003 | 2005/0108118 A1 | May 19, 2005 |
| 09/771,865 | Jan. 29, 2001 | 2002/0032659 A1 | Mar. 14, 2002 |
| 09/777,329 | Feb. 5, 2001 | 20020128849 A1 | Sep. 12, 2002 |
| 10/118,118 | Apr. 6, 2002 | 20030191656 A1 | Oct. 9, 2003 |
| 11/235,908 | Sep. 27, 2005 | 20070073625 A1 | Mar. 29, 2007 |
| 11/430,707 | May 8, 2006 | 20060253480 A1 | Nov. 9, 2006 |
| 09/740,420 | Dec. 19, 2000 | 6,859,782 B2 | Feb. 22, 2005 |

### Foreign Patent Docs

None

### Other References

None

### DESCRIPTION

1) Field of the Invention

This invention generally relates to compensation of engineering services. The invention specifically relates to methods and systems that enable products and services to be developed without up front engineering costs in exchange for fees once the product or service is engaged into the marketplace.

2) Background of the Invention

Inventors and product developers often are deterred by the costs of engineering a product. Many good ideas never make the market due to the expense of developing the product. These expenses are often unpredictable and therefore may also deter potential investors in the product or service. This method of doing business can greatly increase the number of new products brought to the marketplace by relieving the inventor or product developer of the costs associated with fully engineering their product. The engineering provider invests his time and skills at risk into the product. His reward is one of potential multiples of what he would have otherwise charged as an hourly rate to engineer the product. This method of doing business rewards both the product developer and the engineering provider because it encourages all parties to perform at their highest possible level in order to maximize the potential success of the product. This method of doing business can also encourage investors to risk their investment knowing that the engineering of the product will produce the best possible result.

Inventors or Product Developers may be limited in budget preventing the hire of employees or consultants in the Engineering fields who are capable of producing engineering documentation or intellectual property necessary to turn the idea or invention into a product or service. This may prevent the product idea or invention from ever reaching the marketplace. The proposed method of doing business will enable such Inventors or Product Developers to see their ideas or inventions reach marketing stage, without any engineering budget impact. Royalty or contingency payments are made to the Engineering Provider once the product is sold in the marketplace. This royalty or contingency payment continues throughout the life of the product or any derivative thereof., or may transferred or be sold to another company. This method of developing engineering documentation will ensure the highest quality or marketability of the product or service because the monies earned by the Engineering Provider are based entirely on the sales success of the product or service.

3) Summary of the Invention

Provided herein are methods and systems for an inventor or product developer to submit an idea to an engineering provider and a method or system to develop the idea into a product once the terms of the agreement are reached. These terms to be limited to a royalty or a contingency fee only based on the success of the product in the marketplace.

Agreement between the inventor or product developer and the engineering provider to consist of a written contract describing the exact terms of the agreement including the determination of the owner of the engineering documents, the royalty or contingency terms, and termination or buyout provisions.

Engineering Provider is considered to be investing their time and skills into the Inventor or Product Developer's project at risk in exchange for rewards greater than typical compensation.

What is claimed is:

1) Claim business method and system using a computer to produce engineering documents used in the manufacture of a product or to provide a service without fee to the contracting inventor or product developer in exchange for a royalty or contingency based on product sales or revenue.

2) The Method of claim 1, wherein the engineering is used to produce a product or a service in exchange for a royalty or contingency as the product or service is sold.

3) Method of claim 1, wherein the ownership of said engineering documentation is property of engineering provider in the case of a royalty payment or contracting inventor/product developer in the case of a contingency payment.
